(19) United States
(12) Patent Application Publication
(10) Pub. No.: US 2011/0253460 A1
(43) Pub. Date: Oct. 20, 2011

(54) BLADE-TYPE DRILL BIT

(75) Inventors: Gniyatulla Garifullovich ISHBAEV, Ufa (RU); Andrej Grigorievich BALUTA, Ufa (RU); Artur Nailievich SHARIPOV, Ufa (RU)

(73) Assignee: OOO NPP "BURINTEKH", Ufa (RU)

(21) Appl. No.: 13/171,681

(22) Filed: Jun. 29, 2011

Related U.S. Application Data
(63) Continuation-in-part of application No. PCT/RU2009/000498, filed on Sep. 28, 2009.

(30) Foreign Application Priority Data
Dec. 29, 2008 (RU) 2008152613

(51) Int. Cl. E21B 10/46; B23K 1/00; B05D 5/00

(52) U.S. Cl. 175/428; 427/256; 228/101

(57) ABSTRACT

The invention relates to rock destruction tools used for drilling oil and gas wells, especially for drilling slant and horizontal wells and formations having alternating layers of different hardness. The technical effect consist in improved steerability of the drilling bit and higher vibration resistance of polycrystalline diamond cutters (PDC) bit due to the use of a composite plating applied and adjustment of cutter protrusion over this plating. Blade drilling bit includes body with coupling thread, central channel, exit holes for flushing fluid and blades, equipped with polycrystalline diamond cutters PDC. Blade surface is covered with composite plating having different wear resistance depending on thickness, and tolerance of composite plating to abrasion wear increases from the outer surface to sublayers, and the size of cutter protrusion close to the centre of bit over the surface of composite plating is less than required for drilling the hardest formations in given geological section.

### CROSS-REFERENCE TO RELATED APPLICATION

This application claims the benefits from the International Application PCT/RU2009/000498 filed on Sep. 28, 2009 and claiming priority from RU 2008152613 of Dec. 12, 2008. The content of these applications is hereby incorporated by reference in its entirety.

### TECHNICAL FIELD

This invention relates to the rock destructing tool, used for drilling oil and gas wells, especially for drilling of slant and horizontal wells and formations formed as interchanging layers with different degrees of hardness.

### BACKGROUND OF THE INVENTION

In directional drilling, using downhole motor equipped with axis skewing mechanism or bent sub between power and spindle sections, the “torque-load” characteristic of the drill bit is of great importance. Due to great length of a drill rig and the bends thereof as well as due to an increase in inclination angle of the borehole axis, the weight of the drill string can be distributed on the well sides and not reach the bit itself. While offloading the drill string from the boring rig, the drill string weight becomes greater than static friction force against the well wall and the “downfall” of the string from the well walls occurs. This results in a considerable jump in weight on bit (WOB). Thus, drilling of slant and horizontal wells takes place under conditions of considerable inequity in values of axial stress applied to the bit. Herewith, excessive introduction of cutters into the formation and marked increase of torque necessary for the bit rotation take place. If the bit responds to the axial stress changes with a dramatic change in the required torsional moment necessary for rotation thereof, this leads to the twisting of the drill string and uncontrolled variation of whipstock set-up plane angle against well axis, i.e. loss of steerability. It is getting difficult, and in some cases impossible, to control the direction of the well drilling. Therefore, it is necessary to minimize jumping of axial stress, which will translate into the reduction of torque swing, and thus, will consequently increase steerability and vibration resistance of the bit. Vibration resistance is a feature of the bit that prevents rotation of the bit around the centre displaced with respect to the geometric centre of the bit, whereby cutters are displaced to lateral sides and back and are subject to considerably high mechanical load that destroys them. I.e. roll-over of the bit along wells side is taking place—so called “swirling” motion of the bit. This type of rotation is described in the U.S. Pat. No. 4,932,484, MPK E21 B10/26, 40/46, publ. Jun. 12, 1990.

A drilling blade bit PDC (polycrystalline diamond cutters) of cutting type is known, which is a threaded for interconnection to a drill string, wherein a central channel with fluid nozzles for supplying washing fluid and polycrystalline diamond cutters (PDC), disposed on the blades of the bit body (U.S. Pat. No. 6,443,249, MPK E21B0/46, publ. Sep. 3, 2002) are provided. Cylindrical cutting elements are provided with on the cutting edge an oversized conical chamfer with a determined inclination angle. Due to the presence of an oversized chamfer, the cutter is less “aggressive” in comparison to the standard cutter and penetrates the formation less when the axial stress is increased. However, the usage of the knownbit does not solve the problem with drilling of slant and horizontal sections, therefore the torsional moment of the bit still depends highly on the axial stress.

Different cutting depth stoppers are widely used in PDC blade drilling bits to limit excessive penetration of cutters into the formation. Bits with penetration stoppers formed by pads, bullet-type inserts set next to cutters (U.S. Pat. No. 5,558,170, MPK E21B10/46, publ. Sep. 24, 1996) and behind cutters (U.S. Pat. No. 5,265,685, MPK E21B10/46, 10/58, publ. Nov. 30, 1993), wherein, in the latter case, stoppers can be in constant contact with the rock formation. Penetration stoppers allow to reduce cutter breakdown possibility due to excessive stress. But the disadvantage of such bits lies in sharp changes in the torsional moment depending on the axial stress, as penetration stoppers of smaller sizes easily penetrate into the formation. High accuracy requirement for installing stoppers height-wise with respect to the cutter can be also be considered a disadvantage of said bits. It is explained by that fact that each cutter during drill bit work moves along the spiral trajectory, and the angle of the spiral lead differs from several degrees for cutters set near the axis of rotation, to several fractions of a degree for cutters set farther from the axis of rotation next to the peripheral part of the bit. The stoppers in these bits are to interact with formations when the angle of the spiral lead is increased within the range from tenths to hundredths of a degree. Taking into account a small distance between the cutting edge and the stopper set behind the cutter, it is necessary to maintain the precise height size of the stopper unit with respect to the cutter.

A drilling bit is known, wherein the cutting depth stopper is a lug formed in front of the cutter or a group of cutters formed in line from the centre of the bit to the outer circumference thereof (U.S. Pat. No. 5,595,252, MPK E21B10/46, publ. Jan. 21, 1997). In this case, the accuracy of set values of the cutting depth considerably increases. The disadvantage of this bit lies in still unsatisfactory load-torque characteristic.

As the closest prior art in terms of technical essence of the invention and achieved technical effect is a drilling cutting bit comprising a body threaded for interconnection to a drill string, having a central channel with fluid nozzles for supplying washing fluid, and blades provided with polycrystalline diamond cutters (U.S. Pat. No. 6,460,631, IPC 21B10/46, publ. Oct. 8, 2002). The cutters formed in the centre of the bit have reduced protrusion height with respect to the blades. In this case blades of the bit serve as penetration stoppers. By increasing axial stress applied to the bit, the penetration of cutters into the formation increases, the surface of blades in the central part of the bit is starting to come closer to the formation and, upon reaching determined cutting depth values, comes into contact with it. With further increase in the cutting depth, the width, and consequently, the area of contacting paths increases. The cutting depth depends on the bit geometry, compression strength of formation, and axial stress. Due to a large area of contacting surfaces, the formation can be subject to loads several times exceeding the cutting depth with one cutter required to achieve said values. As contacting surfaces are not formed over the whole radius of the bit working area, but only close to axis of rotation, torque caused by friction forces in the contact area is comparatively small. Thus, the gently sloping “torsional moment/axial load” curve is achieved.

Another disadvantage of said prior art analogue is the constant value of the cutter protrusion over bit blades. Due to said characteristic, the drill bit has two sections of “torque-load” curve: the first section where the drill bit acts as a conventional bit, and the second section where its characteristic approaches the characteristic of the roller cone bit. This disadvantage is apparent when drilling slant horizontal sections of wells in formations with interdigitations of layers with different degrees of hardness. For example, when drilling from a softer interlayer to a harder and solid interlayer, penetration depth of the cutter into the formation decreases, and the contact of blades with the formation is lost, the bit starts to act like a conventional drill bit, and as a result, the steerability decreases. When drilling from a harder interlayer to a softer interlayer, the penetration depth of the cutter into the formation increases, and as the cutter protrusion value over blades is constant, and was set, for example, for hard formations, contacting surfaces will limit the drilling speed to 2 . . . 3 times with respect to speed that could be achieved in the given formation without losing the steerability. Stoppers of cutter penetration into formations, according to said invention, do not improve vibration resistance of the bit, as it does not limit displacement of the bit axis with respect to the well.

### BRIEF SUMMARY OF THE INVENTION

The object of the invention is to improve steerability of the drilling bit whilst increasing the vibration resistance of the PDC bit.

The object is solved by a drill blade bit comprising a threaded body, a central channel with exit holes for flushing fluid, and blades equipped with polycrystalline diamond cutters PDC, according to the invention, the blade surface has a composite coating having variable wear resistance depending on the thickness. Protrusion degree of cutters formed close to the centre of the bit, above the composite layer surface, is invariably less than required for drilling the hardest formations in the given geological section.

The disclosed invention differs from the prototype in that the blade surface has a composite coating, having variable wear resistance depending on the thickness, and the protrusion degree of cutters close to the centre of the bit above the coating is invariably less than necessary for drilling the hardest formations in the given geological section.

The coating is formed to provide the increase of abrasion resistance of the coating in the direction from the outer surface to underlaying layers. It could be achieved by, for example, using “layer by layer” coating application with different content of extra-hard phase in the bonding composition by brazing or spraying in case the bit body is formed of steel. In case of so-called “matrix” bit formed by using powder metallurgy, the object of the invention is achieved by mixing the hard phase and a softer phase in the outer layer. For example, tungsten carbide particles in the surface layer can be mixed in a predetermined ratio with tungsten particles or iron, and subsequently, said particles can be saturated with bonding material. Various copper-nickel alloys are typically used as a bonding material.

Surprisingly, it was noticed that the composite coatings applied on the blades surfaces according to the present invention, provide the following advantages:

The coating applied as described in the present invention prevents excess early penetration of cutter into the formation;

The composite coating according to the invention facilitates formation of additional stabilization channels on the surface of the blades.

The present composite coating adapts the bit for reaching necessary ROP in the particular mining and geological and technological conditions, limiting excessive penetration of cutters into the formation, and helps to form stabilization channels as the coating wears due to the friction with formation.

The use of the present invention allows to provide optimal ROP and steerability of PDC bit with increased vibration resistance when drilling slant and horizontal wells, as well as when drilling formations formed as interlayers with different hardness.

Therefore, composite plating performs a new function and allows to achieve the novel effect of bit stabilization with simultaneous improvement of steerability thereof, which proves that the invention meets the requirement of inventive step.

### BRIEF DESCRIPTION OF THE DRAWINGS

The present invention is illustrated by means of the following non-limiting example embodiments shown in the figures:

FIG. 1 is the general view of PDC bit;

FIG. 2 is the rotation torque/axial stress diagram;

FIG. 3 is the operation scheme of the cutter;

FIG. 4 is the top view of the bit;

FIG. 5 is the view of the worn bit used in Example 1.

FIG. 6 is the view of the worn bit used in Example 2.

### DETAILED DESCRIPTION OF THE INVENTION

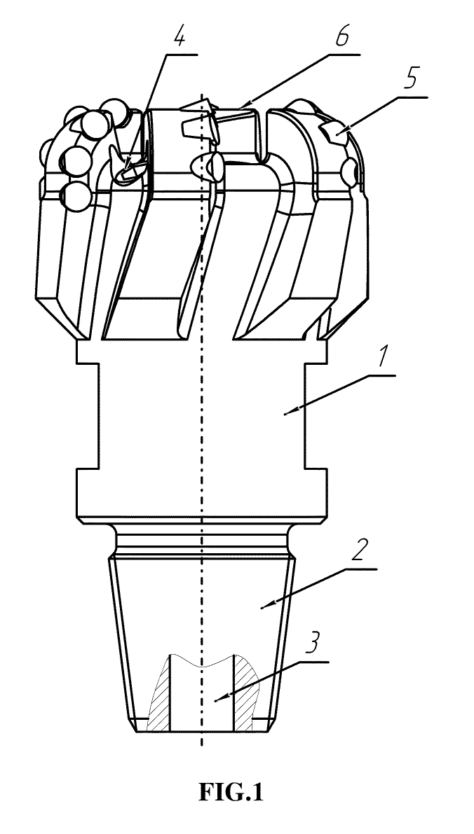

Blade drilling bit, shown in FIG. 1, has a body (1) with a coupling thread (2) connected to the drill string (not shown at the picture), which has central channel (3) with outlets (4) for supplying flushing liquid. On the blades (6) of the bit, polycrystalline diamond cutters (PDC) (5) are formed.

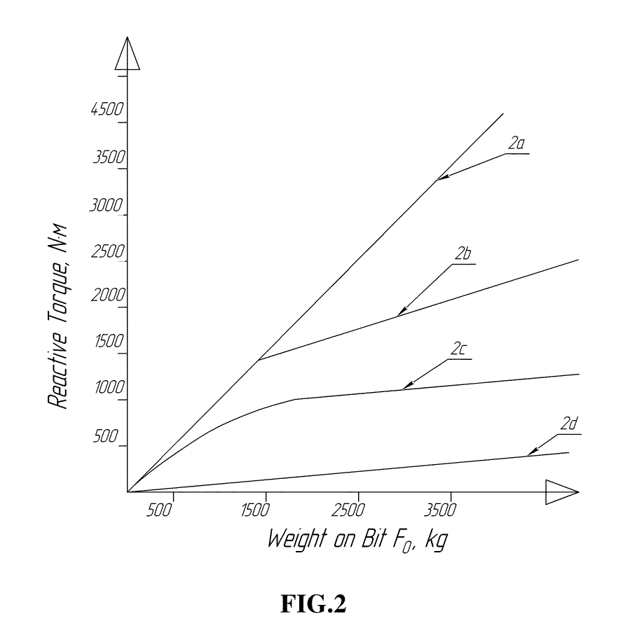

In FIG. 2, a rotation torque/axial stress diagram is shown: straight line 2a is a conventional PDC-bit; curve 2b is the prototype bit; curve 2c is the bit according to the present invention; straight line 2d is the roller cone bit. Conventional cutting bits PDC (FIG. 2, straight line 2a) have a steep “rotation torque—axial stress” characteristic, as cutters easily penetrate the formation when the axial stress is increased, and footage per rotation increases several times in comparison with footage per rotation of roller cone bit with the same axial stress change. This leads to a considerable change in rotation torque applied to the bit. In general case, the required axial stress applied to the cutting bit is 2 . . . 3 times less than the value used for the roller cone bit.

A bit with cutting depth stoppers in the prototype (FIG. 2, curve 2b) has comparatively small rotation torque/axial stress ratio, but the presence of two curve segments is a considerable disadvantage when drilling slant and horizontal wells under conditions of alternating formation hardness.

The rotation torque/axial stress diagram in the present bit (FIG. 2, curve 2c) is more flat in comparison to the prototype and conventional bits, and has no abrupt turning points, thus approaching the characteristics of a roller cone bit (FIG. 2, straight line 2d), which is optimal when drilling slant and horizontal wells.

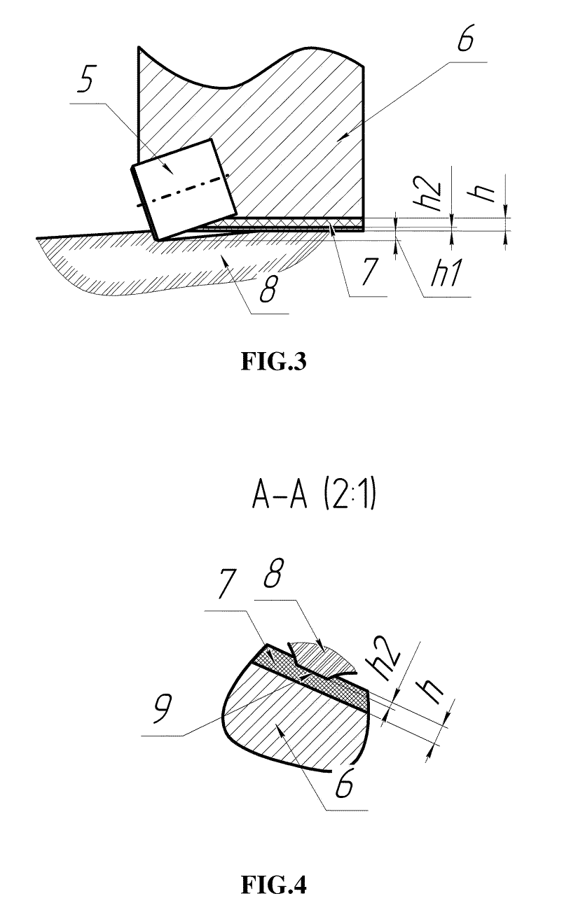

In FIG. 3, the operation scheme of polycrystalline diamond cutter (5) is shown, said cutter fixed in the body of blade (6), with composite plating applied to the blade (7) relative to formation (8). Composite plating is applied according to effective thickness h (0.5 . . . 7 mm), so that the predetermined protrusion h1 (0.1 . . . 5 mm) of cutters over the plating on the female cone of the bit is achieved.

In FIG. 4, top view of the bit that worked for an initial time is shown. As a result of friction between composite plating (7) and the formation (8) and the further partial wear thereof, stabilization channels (9) with depth h2 were formed. In order to provide required drilling rate of cutters (5), it's necessary to achieve penetration depth h3. Value h3 is equal to the sum of values h1+h2 and is optimal for required ROP.

h=h1+h2.

where:
h1 is the distance between the surface of composite plating and the cutting point (5).
h2 is the depth of stabilization channel.

During initial drilling, the cutter penetration into the formation is restricted by the composite plating, preventing the cutter penetration into the formation for a value higher than h1. When drilling starts, the upper layer of the composite plating having low abrasion resistance in comparison to the deeper sublayers, interacts with the formation and begins to wear off, creating additional stabilization channels (9) with depth h2. The formation of said cannels allows the cutters to cut at the depth h=(h1+h2) and provides an optimum ROP. At the same time, the formation of said cannels improves the steerability and the vibration resistance of the bit. Time of wear of composition plating to the value h2 depends on drilling modes and geological factors and lasts 1 to 8 hours. As a result, the bit adjusts to drilling conditions, providing optimal ROP, creating additional stabilization channels (9) that interact with concentric channels in formation at the hole bottom (8), and thus increasing vibration resistance and optimizing rotation torque/axial stress ratio.

When configuring the type of composition plating, thickness and distribution of superhard phase over the thickness of coating layer, geological factors are taken into account, as well as technical and technological conditions.

In general view value h and h1 is calculated according to the analysis of function depending on a variety of parameters, such as bit type, bit size, cutter size, formation properties, projected drilling modes (bit pressure, rotation rate), and also projected ROP.

hᵢ=f(σ, α, Fₐₓ, n, V_{mech}, . . . ),

where:
σ—compression toughness of formation,
α—internal friction angle,
Fₐₓ—projected axial stress,
n—projected rotation rate of downhole motor,
V_{mech}—projected ROP.

### Example 1

Six-bladed drill bit BIT 220.7 BT 613 (type IADC S333) for drilling soft sandstones and clays was used in the tests. These formations typically have strength varying from 4 to 6 kg/mm² in the upper interval of the formation and 15-20 kg/mm² in the lower interval of the drilled formation. The friction angle of these formations usually varies from 44 to 42 in the upper interval and 34 to 36 in the lower interval of the drilled section respectively. The drill bit 220.7 BT 613 is normally used at an average drilling rate from 50 to 70 m/h. The equivalent thrust load required to obtain the said drilling rate at a rotational speed of 280 to 300 rpm, was usually from 5 to 8 t.

The drilling bit blades were coated by a composite coating of hard alloy according to the invention to obtain the final thickness of about h=3 mm. Hard alloy coating was applied by means of lamination layer by layer by gas-flame spraying of a composite powder material produced by, for example, Technicord, Woka. Any other similar powder materials can be used with different concentrations of tungsten carbide (W/C), such as from 5 to 90%.

The first layer of hard alloy coating was applied using Technicord material T-Thermo 655 with WC/matrix ratio of 60%/40% and thickness of 0.75 mm. The second layer of hard alloy coating was applied using Technicord material T-Thermo 640 with WC/matrix ratio of 50%/50% and thickness of 0.75 mm. The third layer of hard alloy coating was applied using Technicord material T-Thermo 630 with WC/matrix ratio of 40%/60% and thickness of 0.75 mm. The fourth layer of hard alloy coating was applied using Technicord material T-Thermo 620 with WC/matrix ratio of 30%/70% and thickness of 0.75 mm. The overall thickness of the coating was 3 mm.

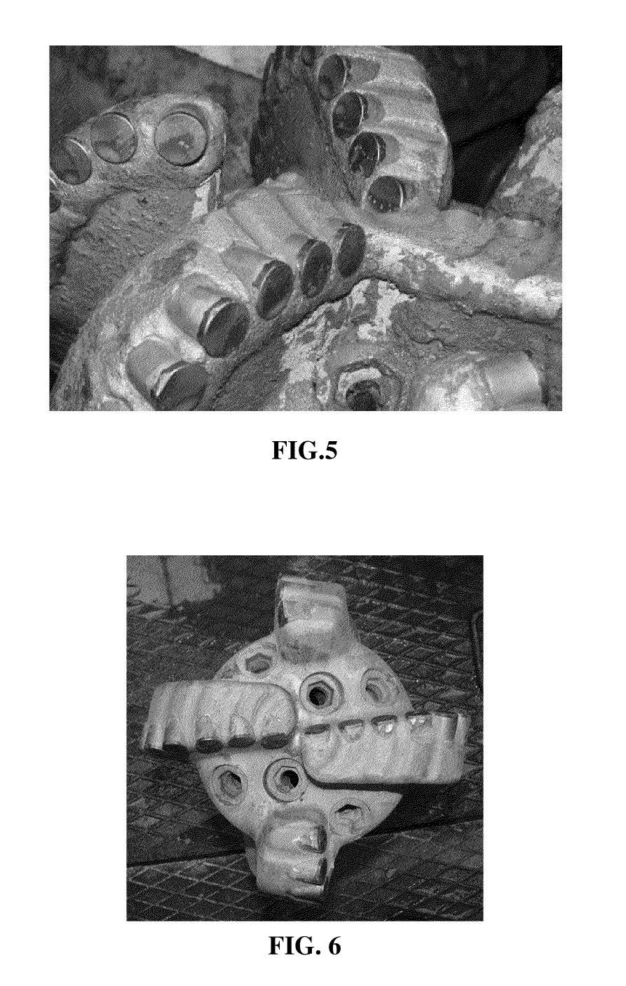

A view of the worn bit is shown in FIG. 5.

When drilling using the coated drilling bit of Example 1, the drilling conditions were used as obtained based on the drill bit calculations as described above. As a result, the following mechanical speeds of drilling were achieved: 120 m/h in the intervals (1500 m . . . 2500 m) and 50 m/h in the interval (2500 m . . . 3000 m). Accordingly, the average drilling rate was 65 m/h. After drilling, characteristic stabilization surfaces were formed on the conical part of bit blades, between the PDC cutters, with the grooves having depth h2=1.5 mm. Reduced vibration and good steerability during drilling were observed. Thus, the technical effect was beneficial since the total drilling process and reduced wear of the drilling bit were achieved. Other drilling conditions can be selected by a specialist in the art using the general knowledge.

### Example 2

According to Example 2, a four-bladed matrix-type drill bit 220.7 BT 416 M (type IADC M333) for drilling soft sandstone and clay was used.

The drilling bit was used to drill a formation having strength varying from 3 to 5 kg/mm² in the upper interval and from 12 to 18 kg/mm² in the lower interval of the drilled section. The friction angle of the formation was from 46-45 in the upper interval and 32-34 in the lower interval of the drilled section respectively. The drill bit of this type is typically designed to achieve average drilling rate from 50 to 70 m/h. The equivalent thrust load to support predetermined drilling rate, at a rotational speed of 180 . . . 220 rpm, was 6 . . . 10 t. The drilling bit was coated to obtain the thickness 4 mm of hard alloy coating on the bit blades.

The drilling bit was prepared in accordance with the technology for producing matrix bits, in particular, using powder metallurgy. In the course of the process, a layer of the hard alloy coating was formed using a method, wherein a powdered alloy material suitable for preparing each layer is poured on top of the preceding layer, starting from bit blades and finishing with tail part of the bit. The powder materials used herein are produced by Woka, Kennametal and others. In the present bit, granulated WC WOKA WN-3 with thickness of 2 mm was used for the first, less hard layer. Granulated WC WOKA W-3 with thickness of 2 mm was used for the second, harder layer. The overall layer thickness was 4 mm. A view of the worn bit is shown in FIG. 6.

The drilling conditions were selected based on the drill bit calculations performed as described above in the description of the present invention. As a result, the following mechanical speeds of drilling were achieved: 140 m/h in the intervals (1500 m . . . 2500 m) and 60 m/h in the interval (2500 m . . . 3000 m). Accordingly, the average drilling rate was 72 m/h. After drilling, characteristic stabilization surfaces were formed on the conical part and the forward end of bit blades, between the PDC cutters, with grooves having depth h2=3 mm. Reduced vibration and good steerability during drilling were observed. Thus, the technical effect was advantageous.

The use of the disclosed invention provides the increase of the drilling rate, consistency of bit operation, thus increasing PDC bit life and reducing the time of well construction not only due to increasing ROP, but also due to less frequent round-trip operations for changing a worn bit. Economic effect is achieved by means of reducing drilling time and reducing drilling tool expenses.

We claim:

1. A blade drilling bit, comprising a body having a central channel and outlets for flushing fluid, and blades provided with polycrystalline diamond cutters (PDC), wherein the blades are coated with a composite coating having a variable abrasion resistance coefficient along its thickness, so that the inner coating layer has the higher abrasion resistance and the upper coating layer having the lower abrasion resistance, and wherein the cutters partially protrude above the surface of the coating.

2. A blade drilling bit of claim 1, wherein the cutters, which are arranged close to the centre of the bit, protrude above the surface of the composite to the extent that is less than required for drilling the hardest formation in given geological section.

3. A blade drilling bit of claim 1, wherein the body is provided with coupling thread for coupling to a drill string.

4. A blade drilling bit of claim 1, wherein the said composite coating is made layer by layer, wherein different layers has different abrasion resistance.

5. A blade drilling bit of claim 1, wherein the said composite coating has an abrasion resistance coefficient gradient across the thickness of the coating.

6. A blade drilling bit of claim 1, wherein the said drilling bit body is made of steel.

7. A blade drilling bit of claim 1, wherein the said composite coating is made by brazing or spraying.

8. A blade drilling bit of claim 6, wherein the said composite coating comprises a plurality of layers which differ in a concentration of hard phase in a binding composition.

9. A blade drilling bit of claim 1, wherein the said bit is made by powder metallurgy.

10. A blade drilling bit of claim 9, wherein the composite coating is formed by admixing a hard phase with less hard phase in the surface layer.

11. A blade drilling bit of claim 10, wherein as the hard phase the coating comprises in the surface layer tungsten carbide particles, and as the less hard phase, tungsten or iron particles.

12. A blade drilling bit of claim 8, wherein the binding composition comprises a copper-nickel alloy.

13. A blade drilling bit of claim 1, wherein the composite coating on the surface of the blades has the thickness of from about 0.1 to about 10 mm, preferably from about 0.5 [symbol] o about 7 mm.

14. A blade drilling bit of claim 1, wherein the composite coating on the surface of the blades provides the cutters protruding above surface of the coating on the inner cone of the bit for height of from about 0.05 to about 7 mm, preferably from about 0.1 to about 5 mm.

15. A blade drilling bit of claim 1, wherein the composite coating provides formation of additional stabilizing grooves on the surface of the blades in the course of drilling.

16. A method for manufacturing a blade drilling bit having blades provided with polycrystalline diamond cutters, the method including the step of
coating the surface of the blades with a composite coating having a variable abrasion resistance coefficient across the coating thickness,
wherein the inner coating layers adjacent to the blade surface has the higher abrasion resistance and the outer coating layers having the lower abrasion resistance, and
wherein the cutters partially protrude above the surface of the coating.

17. A method of claim 16, wherein the said composite coating is applied layer-by layer.

18. A method of claim 16, wherein the said composite coating is formed by brazing or spraying.

19. A method of claim 16, wherein the said drilling bit is made by powder metallurgy.

20. A method of claim 19, wherein the said composite coating is made by mixing a harder phase with less hard phase in the surface layer in the course of forming the drilling bit by powder metallurgy.
